(19) United States
(12) Patent Application Publication
(10) Pub. No.: US 2012/0115557 A1
(43) Pub. Date: May 10, 2012

(54) METHOD AND APPARATUS FOR ASSOCIATING RFID TAGS WITH PARTICIPANTS IN SPORTING EVENTS

(76) Inventor: Arash Kia, Portland, OR (US)

(21) Appl. No.: 13/206,253

(22) Filed: Aug. 9, 2011

Related U.S. Application Data
(63) Continuation of application No. 12/077,490, filed on Mar. 20, 2008, now abandoned.
(60) Provisional application No. 60/936,740, filed on Jun. 22, 2007.

(51) Int. Cl. G06F 19/00; B23P 11/00

(52) U.S. Cl. 463/6; 29/592.1

(57) ABSTRACT

An embodiment of the present invention is a technique for timing participants in sporting events with RFID tags. RFID tags have read and writable memory that is loaded with race numbers or an encoding of it. RFID tags are distributed to participants by attaching them to race bibs that display the race numbers. RFID tags may be left on the race bibs, or removed from the bibs and attached to shoes, clothing, or other apparatus used in the race. A plurality of RFID tags may be used by each participant for pre-race, during race and post-race tracking and locating applications. This invention also includes methods for constructing RFID enabled race bibs.

### RELATED APPLICATIONS

The present application is a continuation of U.S. patent application Ser. No. 12/077,490, filed Mar. 20, 2008 which claims the benefit of the U.S. Provisional Patent Application Ser. No. 60/936,740, filed Jun. 22, 2007. Both of which are herein incorporated by reference in their entirety.

### FIELD OF THE INVENTION

The present invention relates to methods and apparatus for timing participants in a sporting event using Radio Frequency IDentification (RFID) systems.

### BACKGROUND

Radio Frequency IDentification (RFID) systems typically comprise tags, sometimes referred to transponders, readers, antennas, controllers, and software. RFID systems are usually used for locating and identifying objects. RFID systems are specially useful when the number of objects is large and speed and accuracy of the process are essential. In such applications tags are attached to objects and are subsequently read by readers. The system operations are coordinated by controllers and software. Each RFID tag embeds a unique identifier and optionally other data. Readers are capable of communicating with tags and reading tags' unique identifiers. These unique identifiers are associated with objects in controllers and software.

RFID tags and readers use Radio Frequency (RF) waves to communicate. Recent advances in electronics have made it possible to manufacture tags that have no power source of their own. These tags, usually referred to as passive tags, harvest all of their power from the incident RF wave. They modulate and partially reflect the RF wave to communicate with readers. Passive tags are relatively inexpensive to manufacture and can be used as disposable tags.

In many sporting events the participants are ranked based on the time they take to complete a course. Events that have a large number of participants often use RFID systems to identify participants. The RFID systems can also be used to track the participants as they proceed through the race course.

In races that use RFID systems, race participants carry RFID tags, embedded in wrist bands or ankle straps, or attach such tags to their race bibs, shoes, bicycles, boats or other equipment. RFID readers read the tags at the start line, one or more optional mid-points, and at the finish line. For each read operation the tag's identifier and a time stamp is recorded. These records are used to calculate an event completion time for each participant. The completion times are subsequently used to rank the participants.

Current timing systems use a variety of RFID tags and readers, employing many different communication protocols, modulation schemes and frequency band. They use both passive and active tags; active tags include a power source, such as a battery. However, in all cases the readers identify each tag by a unique identifier which in this document will be referred to as the “tag number”.

Race participants are usually required to register with the race organizers prior to the start of the event. Race organizers assign a unique identification number to each participant during the registration process. In this document we will refer to this number as the “race number”. The race numbers are used to uniquely identify the participants before, during, and after the race. Race participants are usually required to carry conspicuous displays of race numbers during the event, usually referred to as “race bibs”.

To use a RFID system for timing participants in a racing event it is necessary to establish a relation between the tag numbers and the race numbers. Today, establishing such relation is labor intensive and error prone. The process typically involves manually entering tag numbers for each participant into a computer program and assuring that the correct tag is delivered to each participant along with the race bibs. The RFID tags are sometimes collected after the event for use in future events. This process is repeated for each event using the RFID system.

### BRIEF SUMMARY

This invention improves the prior art by streamlining and simplifying the process of associating the tag numbers with race numbers and substantially reducing the effort and cost expended on this task.

The present invention provides a method and apparatus for sequencing tag numbers and race numbers and writing the tag numbers into RFID tag memories as to preserve this sequence. In the simplest embodiments the tag numbers are the same as the race numbers and the race numbers are written into tag memories before tags are distributed to race participants. In other embodiments more sophisticated encoding systems can be employed to generate the tag numbers.

According to the present invention the RFID tags are distributed to race participants by attaching them to race bibs, or other items that would have to be distributed to participants in the event, and no extra effort is required to distribute or keep track of RFID tags or tag numbers. In some embodiments the tags are disposable and do not need to be collected from the race participants. Using disposable tags can provide significant labor and cost savings for event organizers.

In some embodiments the RFID tags are attached to race bibs before tag numbers are written to their memories while in other embodiments RFID tags are encoded with tag numbers in correct sequence before being attached to race bibs.

The features and advantages of the invention can be better understood by studying the detailed specification and drawings included here.

### BRIEF DESCRIPTION OF THE DRAWINGS

Embodiments of invention may best be understood by referring to the following description and accompanying drawings that are used to illustrate embodiments of the invention. In the drawings:

FIG. 1 is a diagram illustrating the components of a RFID timing system that can benefit from embodiments of the current invention.

FIG. 2 is a diagram illustrating a race bib with a printed race number and attached RFID tags.

FIG. 3 is a diagram illustrating a race participant wearing multiple RFID tags.

FIG. 4 is a diagram illustrating a method for attaching RFID tags to race bibs, printing race numbers and writing to RFID tag memories.

FIG. 5 is a diagram illustrating a method for writing to RFID memories before attaching them to race bibs.

### DETAILED DESCRIPTION

The current invention is directed to methods and apparatus for associating RFID tags with race participants. The invention is also directed at improving the process of preparing and distributing RFID tags to race participants.

In accordance with the present invention the RFID tags store their data in read/write memory. The read/write memory can be accessed and modified after the tag manufacturing is complete. The ability to modify the data in tag memory allows the race organizers to associate a RFID tag with a race number and then write the correct race number or an encoding of it to the tag memory. In the simplest embodiments of the invention tag numbers, contained in the tag memory, are modified to be the same as the race numbers.

In sporting events, RFID tags and race numbers must be distributed to event participants. Race numbers are usually printed on race bibs that are worn by participants during a race. The race bibs are distributed to participants either by mail or in person prior to the race. In current systems, RFID tags, also referred to as chips, are also distributed to race participants prior to the race and are collected after the race. In such systems, the data in RFID tags are in Read Only Memory (ROM). Therefore, it is necessary to keep track of tag numbers and associate them with race numbers printed on race bibs. An embodiment of the present invention uses RFID tags with writable memory and writes the race numbers, or encodings of them, to tag memories while attaching the tags to race bibs. This process eliminates the need to distribute RFID tags and race numbers as independent entities. Event organizers need to arrange only the distribution of the race bibs to participants, eliminating the cost and effort associated with distributing and collecting RFID tags for each event.

In the following description, numerous specific details are set forth. However, it is understood that embodiments of the invention may be practiced without these specific details. In other instances, well-known devices, structures, and techniques have not been shown to avoid obscuring the understanding of this description.

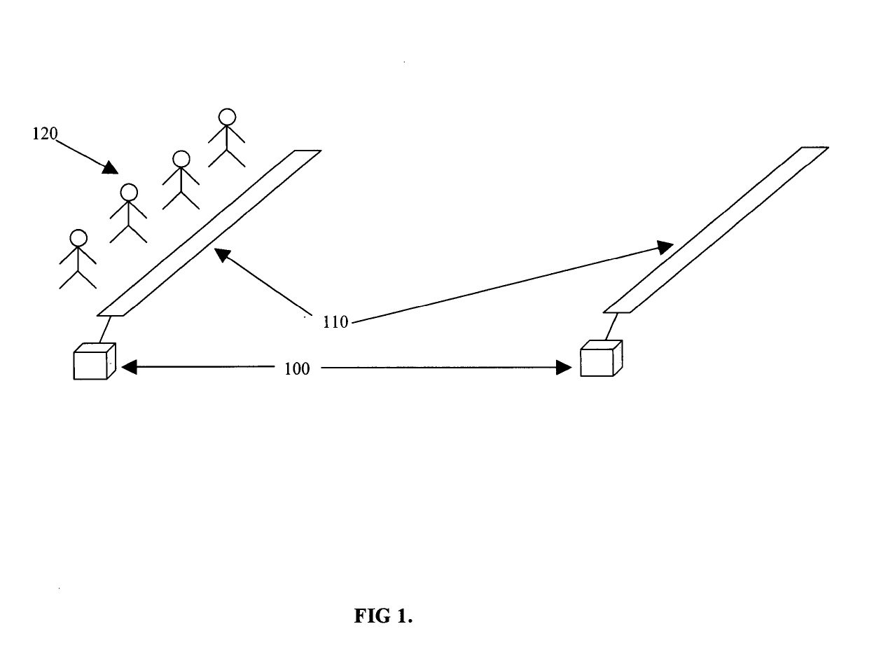

FIG. 1 shows typical components of a RFID timing system that can benefit from the embodiments of this invention. In this system exist one or a plurality of RFID readers, controllers and associated software 100, one or a plurality of antennas 110, and a plurality of participants carrying RFID tags 120. The RFID tag numbers are read as participants pass through the read field of antennas. The tag numbers and read times are recorded by the system hardware and software and are used to calculate the time each participant took to complete the course. The time durations are used to rank the participants. The participants may start the race at different times. The tag numbers and time stamps may be collected at intermediate points through out the race course.

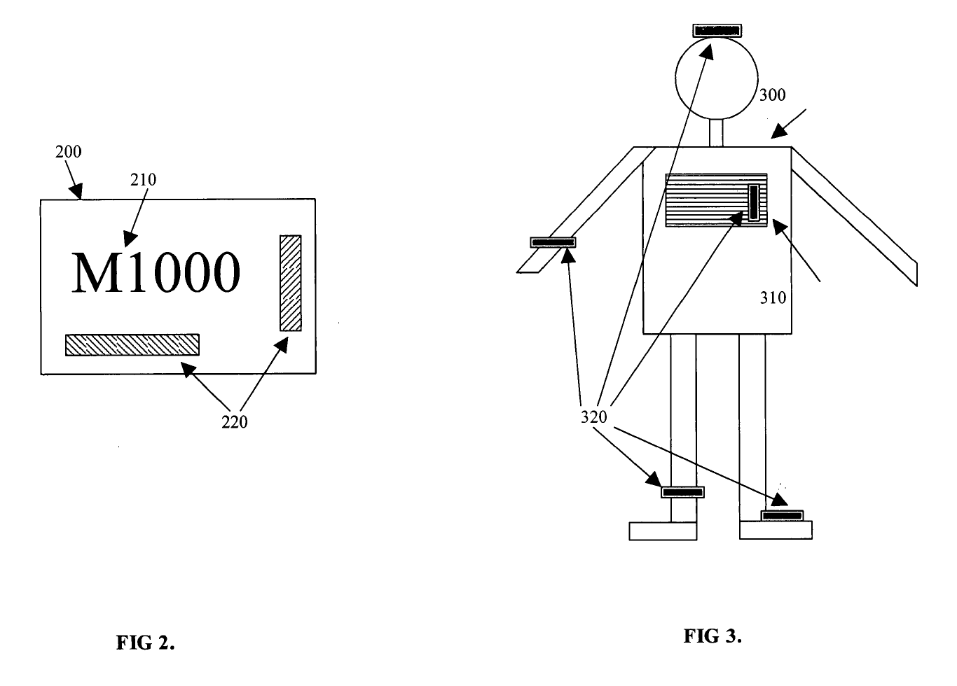

FIG. 2 shows a race bib 200 according to the present invention. It comprises a printed race number 210 and one or a plurality of RFID tags 220. The race number or an encoding of it is written to the memory in each RFID tag.

FIG. 3 shows a race participant 300 wearing a race bib 310. One or a plurality of RFID tags 320 are attached to race bibs, some of which may be detached from the bib and attached to shoes, clothing, or other apparatus such as wrist or ankle straps, helmets, bicycles, boats and clothing articles or sporting equipment.

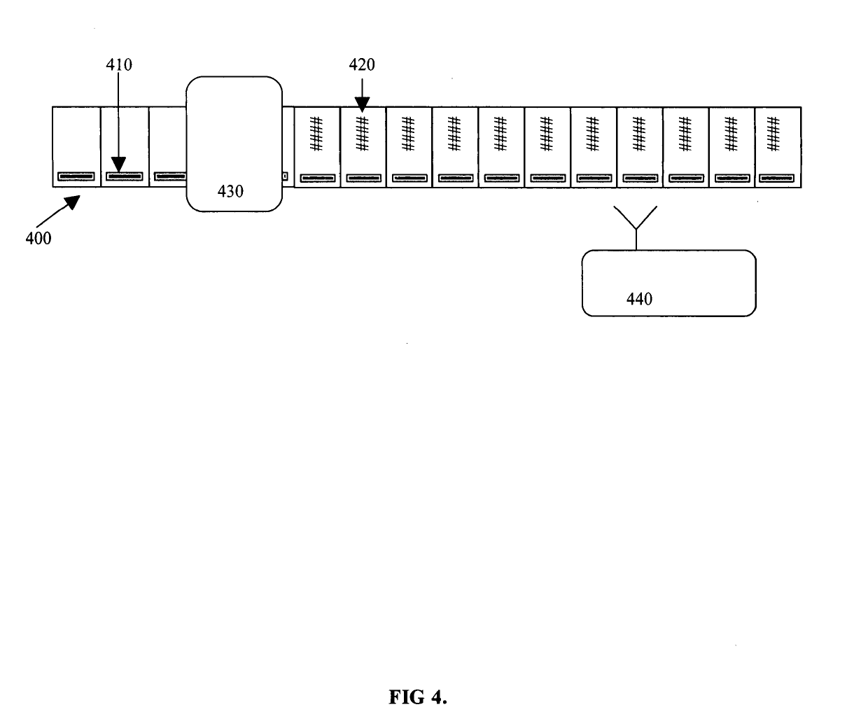

In one embodiment of the invention, shown in FIG. 4, RFID tags 410 are attached to the race bibs 400 before race numbers 420 are printed on race bibs or are written to RFID tag memories. The race bibs are then fed through an ink printer 430 that prints the race numbers on race bibs. The bibs are then passed through a RFID printer 440 which writes the race numbers into tag memories. The ink printer and the RFID printer print and write the race numbers in the same sequence, starting from the same number. The race bibs are then separated from each other and distributed to event participants. According to the present invention it is also possible to switch the printing order such the race bibs pass through the RFID printer first and then they go through the ink printer.

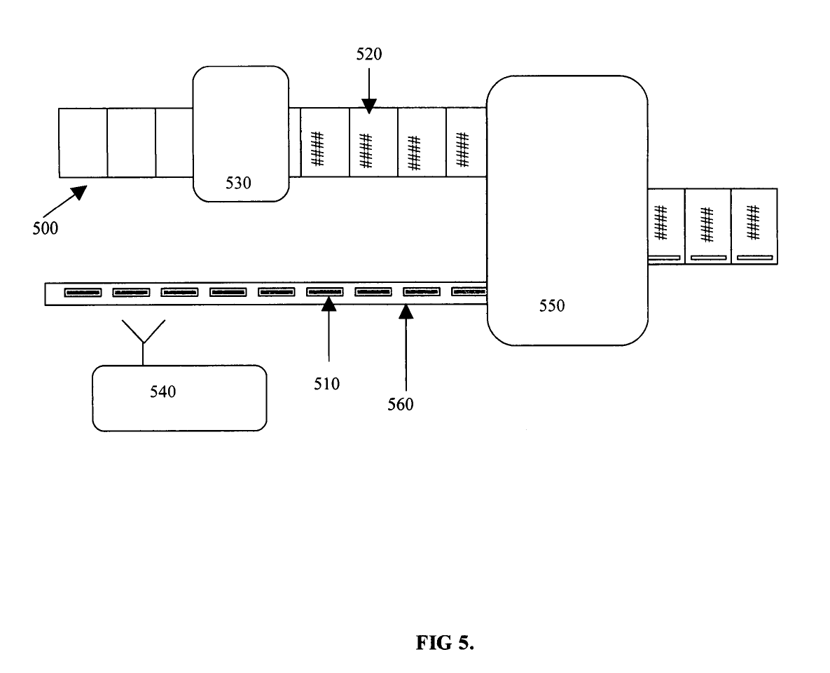

In a different embodiment of the invention, shown in FIG. 5, RFID tags 510 are attached to a backing material 560 and are passed through a RFID printer 540. The RFID printer writes the race numbers, or an encoding of them, into tag memories. In FIG. 5, the race numbers are printed on race bibs 500, by an ink printer 530. The sequence of race numbers printed by the RFID printer and the ink printer are the same. After printing, the RFID tags are transferred from the backing material to race bibs by a device 550 while preserving their order. The race bibs are then separated and distributed to race participants.

What is claimed is:

1. An RFID race timing system comprising: RFID tags, RFID readers, RFID antennas, controllers, software, race bibs, and race numbers; and
RFID tags having writable memory to be programmed with race numbers.

2. The system of claim 1, wherein RFID tags are attached to race bibs prior to distribution of race bibs to race participants.

3. The system of claim 1, wherein one or more RFID tags are assigned to participants by writing their race number in the RFID tag memory.

4. The system of claim 1, wherein instead of the race number a unique encoding of it is written in the RFID tag memory.

5. The system of claim 1, wherein the RFID system is used to record the time participants start and/or finish a course.

6. The system of claim 1, wherein the RFID system is used to record the time participants pass through intermediate points on a race course.

7. The system of claim 1, wherein one or a plurality of RFID tags are used by a single participant or teams of participants.

8. The system of claim 1, where participants detach one or more RFID tags from race bibs and attach them to their shoes, wrist bands, ankle bands, bicycles, helmets, boats, or other clothing or equipment.

9. The system of claim 1, where the RFID tags are used to track participants, or their assets, or their equipment prior to the start of the race, during check in, or line up, or warm up or other pre-race event.

10. The system of claim 1, where the RFID tags are used to track participants, or their assets, or their equipment after the race completion, during award ceremonies, celebrations or other post-race event.

11. The system of claim 1, where the RFID tags are used to track or locate participants' belongings prior, during, or after the race.

12. The system of claim 1, wherein the participants use bicycles, vehicles, boats, and/or other equipment required in the sport.

13. A printing and manufacturing method for race bibs where one or more RFID tags are attached to race bibs before, during, or after printing the race numbers onto race bibs.

14. The method of claim 13, where race numbers or a unique encoding of them are written to RFID tag memories before, during, or after printing race numbers.

15. The method of claim 13, where race bibs are used to distribute RFID tags to participants.

16. The method of claim 13, where the RFID tags are used to time the participants in a sporting event.

17. The method of claim 13, where participants leave one or multiple RFID tags attached to the race bib, or detach one or multiple RFID tags from race bibs and attach them to their shoes, wrist bands, ankle bands, bicycles, helmets, boats, or other clothing, race gear, or equipment.

18. The method of claim 13, where the RFID tags are used to track or locate event participants, or their assets, or equipment prior, during, or after the race.
